(19) United States
(12) Patent Application Publication
(10) Pub. No.: US 2026/0039560 A1
(43) Pub. Date: Feb. 5, 2026

(54) IMPROVED ACCURACY OF ANALYTICS IN A WIRELESS COMMUNICATIONS NETWORK

(71) Applicant: Lenovo (Singapore) Pte. Limited, Singapore (SG)

(72) Inventors: Emmanouil Pateromichelakis, Viersen (DE); Konstantinos Samdanis, Munich (DE); Dimitrios Karampatsis, Ruislip (GB)

(73) Assignee: Lenovo (Singapore) Pte. Limited, Singapore (SG)

(21) Appl. No.: 19/100,660

(22) PCT Filed: Sep. 13, 2022
(86) PCT No.: PCT/EP2022/075414

§ 371 Date: Feb. 3, 2025

(30) Foreign Application Priority Data
Aug. 3, 2022 (GR) 20220100633

(51) Int. Cl. H04L 41/14

(52) U.S. Cl. CPC H04L 41/14

(57) ABSTRACT

There is provided a data analytics function comprising a processor and a receiver. The processor is arranged to generate analytics data for an analytics service using at least one data source. The receiver is arranged to receive an event related to the analytics service. The processor is further arranged to determine a rating of the at least one data source, the rating based on supplementary data.

### FIELD

The subject matter disclosed herein relates generally to the field of implementing improved accuracy of analytics in a wireless communications network. This document defines a data analytics function, a method in a data analytics function, a data storage entity, and a method in a data storage entity.

### BACKGROUND

In 3GPP, data analytics services are provided by the Network Data Analytics Function (NWDAF) (see 3GPP TS 23.288 v17.5.0) and aim to support network data analytics services in the 5G Core network. Such analytics can collect data from other Network Functions (NFs), or Application Function (AF) or Operations and Maintenance (OAM) and can be exposed to a third party and/or AF to provide statistics and predictions related to the operation of the wireless communication network. Such statistics and predictions may relate to slice Load level, observed Service experience, NF Load, Network Performance, UE related analytics (mobility, communication), User data congestion, Quality of Service (QoS) sustainability, Data Network (DN) performance, etc. Moreover, in 3GPP SA5 (3GPP TS 28.533 v17.2.0), management data analytics service (MDAS) provides data analytics for the network. MDAS can be deployed at different levels, for example, at domain level (e.g. Radio Access Network (RAN), Core Network (CN), network slice subnet) or in a centralized manner (e.g. in a Public Land Mobile Network (PLMN) level). The objective of MDAS is to optimize the management plane (in network/domain level, in slice/slice subnet level) by performing analytics based on network management data. Such service can be exposed to the third party/MDAS service consumer to provide PM analytics, FM Analytics, Network Slice instance (NSI)/Network Slice Subnet Instance (NSSI) analytics, optionally recommend appropriate management actions e.g., scaling of resources, admission control, load balancing of traffic, etc. An additional analytics function in 3GPP is discussed in 3GPP SA6 (3GPP TR 23.700-36 v0.4.0) where an application data analytics enablement service (ADAES) is defined for performing app layer and edge/cloud analytics outside 3GPP domain.

In 3GPP TR 23.700-81 v0.3.0 (titled: Study on Enablers for Network Automation for 5G—phase 3), one key issue that is discussed is Key Issue #1: How to improve correctness of NWDAF analytics. Correctness of predictions is usually associated to accuracy, which represents the most prominent Key Performance Indicators (KPI) to rate Machine Learning (ML) models. However, the accuracy can be corrupted by a drift related to a mismatch between training data and inference data. It is thus of utmost importance to ensure accuracy. Incorrect predictions can be due to the fact that the accuracy of an ML model during inference may be lower than the accuracy of the same ML model during training. This is likely to happen if the training data set differs significantly in terms of distribution, range and features from the input data that the ML model is fed with during inference.

### SUMMARY

A data analytics function as defined herein tends to provide improved analytics data. This is done by facilitating detection of correctness of analytics data and the correcting of analytics data. The improved data analytics tend to be provided as a result of a rating of data sources used for analytics. The rating can be used as a criterion for selecting from which sources to collect data, thus improved the quality of the analytics service.

Disclosed herein are procedures for providing improved accuracy of analytics in a wireless communications network. Said procedures may be implemented by a data analytics function, a method in a data analytics function, a data storage entity, and a method in a data storage entity.

Accordingly, there is provided a data analytics function comprising a processor and a receiver. The processor is arranged to generate analytics data for an analytics service using at least one data source. The receiver is arranged to receive an event related to the analytics service. The processor is further arranged to determine a rating of the at least one data source, the rating based on supplementary data.

There is further provided a method in a data analytics function, the method comprising: generating analytics data for an analytics service using at least one data source; receiving an event related to the analytics service; and in response to receiving the event, determining a rating of the at least one data source, the rating based on supplementary data.

There is further provided a data storage entity comprising a receiver and a memory. The receiver is arranged to receive a rating of at least one data source. The memory is arranged to store the rating of the at least one data source.

There is further provided a method in a data storage entity, the method comprising: receiving a rating of at least one data source; and storing the rating of the at least one data source.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for providing improved accuracy of analytics in a wireless communications network will now be described, by way of example only, with reference to the accompanying drawings, in which:

FIG. 1 depicts an embodiment of a wireless communication system for providing improved accuracy of analytics in a wireless communication network;

FIG. 2 depicts a user equipment apparatus that may be used for implementing the methods described herein;

FIG. 3 depicts further details of the network node that may be used for implementing the methods described herein;

FIG. 4 illustrates a method in a data analytics function;

FIG. 5 illustrates a method in a data storage entity;

FIG. 6 illustrates a solution presented herein;

FIG. 7 illustrates an implementation for ANLF-based rating and storage at an ADRF; and

FIG. 8 illustrates an alternative implementation that uses another network function, in particular a Trusted Rating Logical Function, for performing data source rating.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

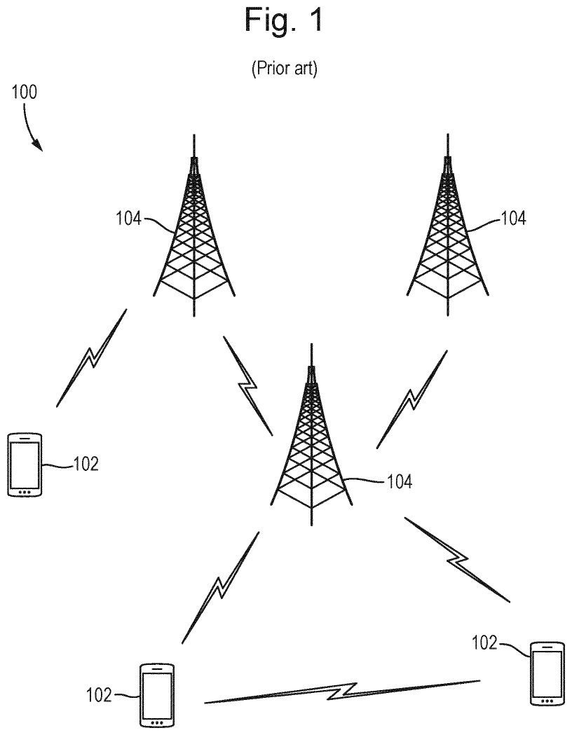

FIG. 1 depicts an embodiment of a wireless communication system 100 for providing improved accuracy of analytics in a wireless communications network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may be a user equipment apparatus 200, an analytics consumer 710, 810, or a data source 840 as described herein. The network unit 104, may be a network node 300, an analytics consumer 710, 810, an NWDAF 720, 730, 825, a data source 740, 840, an ARDF 850, or a TRLF 860 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In 3GPP, data analytics services are provided by the Network Data Analytics Function (NWDAF) (see 3GPP TS 23.288 v17.5.0) and aim to support network data analytics services in the 5G Core network. Such analytics can collect data from other Network Functions (NFs), or Application Function (AF) or Operations and Maintenance (OAM) and can be exposed to a third party and/or AF to provide statistics and predictions related to the operation of the wireless communication network. Such statistics and predictions may relate to slice Load level, observed Service experience, NF Load, Network Performance, UE related analytics (mobility, communication), User data congestion, Quality of Service (QoS) sustainability, Data Network (DN) performance, etc. Moreover, in 3GPP SA5 (3GPP TS 28.533 v17.2.0), management data analytics service (MDAS) provides data analytics for the network. MDAS can be deployed at different levels, for example, at domain level (e.g. Radio Access Network (RAN), Core Network (CN), network slice subnet) or in a centralized manner (e.g. in a Public Land Mobile Network (PLMN) level). The objective of MDAS is to optimize the management plane (in network/domain level, in slice/slice subnet level) by performing analytics based on network management data. Such service can be exposed to the third party/MDAS service consumer to provide PM analytics, FM Analytics, Network Slice instance (NSI)/Network Slice Subnet Instance (NSSI) analytics, optionally recommend appropriate management actions e.g., scaling of resources, admission control, load balancing of traffic, etc. An additional analytics function in 3GPP is discussed in 3GPP SA6 (3GPP TR 23.700-36 v0.4.0) where an application data analytics enablement service (ADAES) is defined for performing app layer and edge/cloud analytics outside 3GPP domain.

In 3GPP TR 23.700-81 v0.3.0 (titled: Study on Enablers for Network Automation for 5G—phase 3), one key issue that is discussed is Key Issue #1: How to improve correctness of NWDAF analytics. Correctness of predictions is usually associated to accuracy, which represents the most prominent Key Performance Indicators (KPI) to rate Machine Learning (ML) models. However, the accuracy can be corrupted by a drift related to a mismatch between training data and inference data. It is thus of utmost importance to ensure accuracy. Incorrect predictions can be due to the fact that the accuracy of an ML model during inference may be lower than the accuracy of the same ML model during training. This is likely to happen if the training data set differs significantly in terms of distribution, range and features from the input data that the ML model is fed with during inference.

For this key issue multiple solutions have been proposed. Sixty such solutions are listed in 3GPP TR 23.700-81 v0.3.0, numbered as solutions #1 to #60. These solutions can be sub-divided into solutions that propose the NWDAF determines the analytics accuracy, solutions where the analytics consumer receive feedback from NWDAF and solutions that improve the accuracy of analytics.

For a first category of solutions, where NWDAF determining analytics accuracy, the solutions can be further sub-divided in the following sub-categories.

Solutions proposing NWDAF (ANLF) determines analytics accuracy (Solutions: 1, 3, 6, 28, 29, 32). Solutions can be further sub-divided in solution comparing analytic output with real-time data (i.e. “ground truth” based solutions 3, 6, 28, 29 and solutions where the ANLF uses multiple ML models to determine analytic output (aggregates ML Models) (Solutions 1, 32). Some solutions propose the MTLF to subscribe to ANLF for monitoring the performance of an ML model.

Solutions proposing NWDAF (MTLF) determines analytics accuracy by determining ML model drift (Solutions: 4, 36).

Solutions proposing utilizing both ANLF and MTLF to determine analytics accuracy (Solutions 5, 30).

Where reference is made herein to NWDAF, it should be understood that this may refer to either an NWDAF Analytics Logical Function (ANLF) or an NWDAF Model Training Logical Function (MTLF). There are advantages and disadvantages whether the ANLF or MTLF determines the analytics accuracy. For example, processing and storage impact on the ANLF is increased if the ANLF in addition to inference also compares analytics output with real-time data, and for the MTLF case the MTLF needs to track the data used for training the ML model and compare them with real-time data.

For a second category of solutions, where the analytics consumer determines analytics accuracy, the solutions can be further sub-divided as follows.

Solutions where the consumer compares multiple analytics output all the possible ground truth from multiple analytics outputs (Solution 31).

Solutions where the NWDAF ANLF registers to the NRF the accuracy of operation (Solution 34).

For a third category of solutions, the NWDAF determines if the analytics need correction (e.g. by updating the ML model). The solutions can be further sub-divided as follows.

Introducing a new NF to monitor changes in network environment that would require update of ML model (Solution 7, 35).

Introduce a new Analytics ID to divide the network into sub-areas with similar data statistics (data statistics refer to data distribution, i.e., the information on values—or intervals—of the data such as network load, network utilization, traffic usage, UE behavior, etc.) and monitor potential deviations that would require to trigger re-training at NWDAF MTLF.

Analytics consumers provide feedback that analytics output negatively impacts the expected performance beyond a predefined threshold limit (Solution 3).

NWDAF ANLF reporting to consumer error and correct analytics if the prior analytics output is inaccurate (Solution 33).

Data Producer providing weight factors to assist the NWDAF to determine how to use input data (Solution 2).

Current solutions which enable NWDAF to determine possible correction of the drift assume that all data sources are trusted. Such an assumption is rational where an NF and/or MnS that belong to the same operator and/or provide a reliable source of data. The accuracy of analytics output may be reduced due to various reasons (data source, data itself, environment) but none of the existing solutions provide details on how the correctness of analytics is ensured when the problem is the data source itself. Further, the above referenced solutions fail to examine how the possible analytics output accuracy is mapped or associated to the data sources reliability.

It should be noted that there are data sources used for providing analytics input that are not within the network operator premises to control and check easily errors and security. For these types of sources, the quality of the data may be questionable. Reduced data quality may be indicated by a significant change in the data distribution or if there is a significant drift between predictions and ground truth data.

Examples of such data sources (from 3GPP TS 23.288 v17.5.0) can be the following:
Service Experience Analytics;
NF load;
DN performance Analytics;
UE related Analytics; and/or
User data congestion analytics

Service Experience Analytics may use inputs from an AF related to the Locations of Application (represented by the DNAI). Service Experience Analytics may use Service Experience measurements from AF which refer to the Quality of Experience (QoE) per service flow as established in the SLA and during onboarding. Such measurements may be either e.g., Mean Opinion Score (MOS) or video MOS as specified in ITU-T P.1203.3 or a customized MOS for any kind of service including those not related to video or voice. Service Experience Analytics may use QoE metric from UEs (via AF) as observed by the UE. Such QoE metrics and measurements are described in TS 26.114, TS 26.247, TS 26.118, TS 26.346, TS 26.512 or ASP specific QoE metrics, as agreed in the SLA with the MNO, may be used. Service Experience Analytics may use performance data from AF as well as from OAM, or indeed other inputs from OAM, NFs.

The NF load may require inputs such as MDT input data for UE via OAM; Per UE attributes to be collected and processed by the AF (route, speed, direction, time of arrival); and AF input data to the NWDAF for Collective Behaviour of UEs.

DN performance Analytics may require inputs such as Performance Data from AF e.g., average Packet Delay, Average Loss Rate and Throughput.

UE related Analytics may comprise expected UE Behaviour parameters specified in 3GPP TS 23.502 v17.5.0, service data from AF related to UE mobility.

User data congestion analytics may comprise measurements collected from a User Plane Function (UPF) or from the AF or from OAM related to User Data Congestion Analytics.

In all these examples, the NWDAF may receive inputs from one or more similar data sources (i.e., similar means data source that can complement or even provide the same data), where some of them can be related to the AF/Server measurements or UE related data. For some of them, similar data (e.g., performance data) can be derived from either the application layer or from networking stacks at the UPF or at the DN side or from the app of the UE itself via application layer signaling (UE-AF-NWDAF or via ADAEC-ADAES AF-NWDAF).

In such cases, a possible drift may be due to an issue of the data source, and such issue may not be in the control of the Mobile Network Operator (MNO) to examine whether the data source itself (which can be trusted or untrusted) provides correct inference data.

There is provided herein a mechanism which can detect possible drift due to data source abnormal/unreliable behavior, (i.e., from a data source that is not in the control of the operator) at the NWDAF side.

Further, there is provided a mechanism that allows for dynamically re-acting to the detection of a drift caused by an abnormal data source to ensure minimum impact to the analytics service accuracy.

The solution presented herein provides a complementary solution in the 3GPP TR 23.700-81 Key Issue #1 related to how to detect and improve correctness of NWDAF analytics. The solution presented herein enables a rating of the data sources. Such a rating can be based on (i) local estimation/calculation between the predicted and ground-truth data, (ii) the analytics consumer feedback, or (iii) provided by an AF in the forms of weights. Hence, the NWDAF generates a rating related to the data source profiles/reputation, which can be used as criterion for selecting from which sources to collect data. In the selection of the appropriate data source, the NWDAF can also use as a criterion the expected confidence degree, i.e., that relates the outcome result with the input data sources. The solution presented here is more applicable for analytics which take inputs from UEs (via AF) or from AF which cannot be as trusted as OAM and NFs (as the analytics services exemplified above). It should be noted that the granularity of rating may be provided per analytics ID or per analytics event ID or per analytics service area or per data statistics range related to an analytics ID.

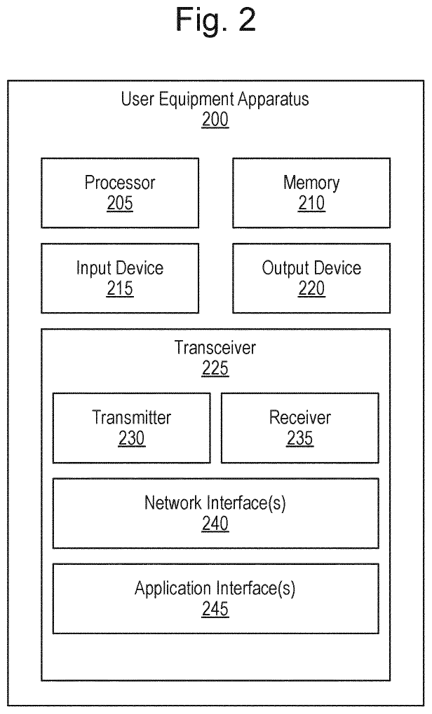

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. The user equipment apparatus 200 may be a remote unit 102, an analytics consumer 710, 810, or a data source 840 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

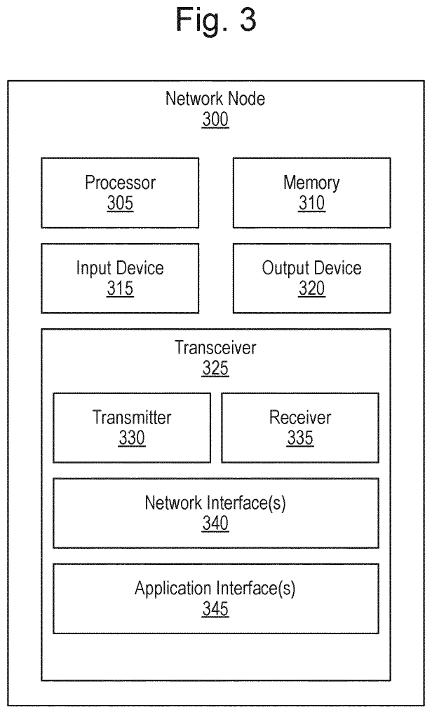

FIG. 3 depicts further details of the network node 300 that may be used for implementing the methods described herein. The network node 300 may be a network unit 104, an analytics consumer 710, 810, an NWDAF 720, 730, 825, a data source 740, 840, an ARDF 850, or a TRLF 860 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Accordingly, there is provided a data analytics function comprising a processor and a receiver. The processor is arranged to generate analytics data for an analytics service using at least one data source. The receiver is arranged to receive an event related to the analytics service. The processor is further arranged to determine a rating of the at least one data source, the rating based on supplementary data.

A data analytics function as defined herein tends to provide improved analytics data. This is done by facilitating detection of correctness of analytics data and the correcting of analytics data. The improved data analytics tend to be provided as a result of a rating of data sources used for analytics. The rating can be used as a criterion for selecting from which sources to collect data, thus improved the quality of the analytics service.

The data analytics function may be located at OAM, MDAS or at an application layer such as ADAES. The event may comprise an evaluation of the analytics service. The event may comprise an evaluation per analytics ID or per analytics event ID or per analytics service area or per data statistics range related to an analytics ID. The evaluation may comprise a level of accuracy, a performance, or correctness. The analytics service may be used by a consumer. The consumer may be another analytics function (e.g. MTLF, ANLF). The event related to the analytics service may be received from the consumer. The supplementary data may comprise a previous rating of the at least one data source. The supplementary data may comprise a historical rating of the at least one data source.

The processor may be further arranged to identify a rating of the at least one data source as below a predetermined threshold, and to trigger a corrective action in respect of the at least one data source having a rating below the predetermined threshold.

The corrective action may comprise: requesting supplementary data from one or more further data sources; updating the stated accuracy of the analytics report; updating a mapping of the one or more data source to the analytics service; or some combination thereof.

The event may be received by at least one of: an analytics consumer, an analytics producer, NWDAF, an NWDAF ANLF, an NWDAF MTLF, an AF, or any combination thereof.

The at least one data source may comprise a UE, an AF, or a network element. The network element may be operated by a network operator different to the operator of the data analytics function.

The processor may be further arranged to determine a rating of a data source by verifying data from the data source by comparing data from the data source with the supplementary source. The supplementary data may be provided by another data source. The supplementary source may be the source generating and/or providing the supplementary data. Examples of the supplementary source can be a network function, a management function, another UE, or another AF. The supplementary source may provide data of the same data type as the original data. The data type may comprise any of real-time data, network data, user data and/or granularity. The supplementary source may provide data of a different type but focusing on the same parameter. Such supplementary data may comprise QoS data from the wireless communication network, QoS data from an application server, or QoS data from a UE. The another data source may be a data source of the same type. The another data source may be a data source that targets the same analytics service, service area or analytics event.

Determining a rating of the at least one data source may comprise obtaining a data source contribution weight. The data analytics function may further be arranged to store the rating in a data storage entity. The data storage entity may be an ADRF.

The transmitter may be further arranged to send the data source rating to at least one network node. The at least one network node may comprise the consumer. The transmitter may be arranged to send the data source rating to at least one application entity. The transmitter may be arranged to send the data source rating to at least one of: an analytics consumer, an analytics producer, NWDAF, ANLF, MTLF, AF, and a UE.

Where the receiver is arranged to receive an event related to the evaluation of the analytics service from a particular node, then the transmitter may be further arranged to send the data source rating to the particular node. In an alternative, the data analytics function report the data source rating to a node other than particular node from which the event related to the evaluation of the analytics service was received.

The transmitter may be further arranged to send a report of the corrective action to at least one network node. The at least one network node may comprise the consumer.

The determined rating may comprise a confidence degree. The rating may be further based on previous data source ratings. The previous data source ratings may be retrieved from a data storage entity. The previous rating of the at least one data source may comprise an historical rating of the at least one data source.

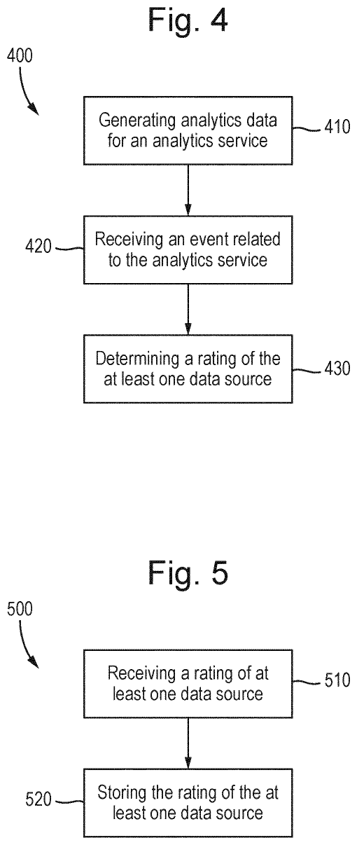

FIG. 4 illustrates a method 400 in a data analytics function. The method 400 comprises: generating 410 analytics data for an analytics service using at least one data source; receiving 420 an event related to the analytics service; and in response to receiving the event, determining 430 a rating of the at least one data source, the rating based on supplementary data.

The event may comprise an evaluation of the analytics service. The event may comprise an evaluation per analytics ID or per analytics event ID or per analytics service area or per data statistics range related to an analytics ID. The rating may comprise a level of accuracy, a performance, or correctness.

There is further provided a data storage entity comprising a receiver and a memory. The receiver is arranged to receive a rating of at least one data source. The memory is arranged to store the rating of the at least one data source.

A data storage entity as described herein tends to provide improved analytics data. This is done by facilitating the collection of the ratings of data sources used for analytics. The rating can be used by analytics service providers as a criterion for selecting from which sources to collect data, thus improving the quality of the analytics service.

The data storage entity may further comprise a transmitter, the transmitter arranged to send the rating of the at least one data source to a data analytics function. The stored previous rating of the at least one data source may comprise an historical rating of the at least one data source.

FIG. 5 illustrates a method 500 in a data storage entity. The method 500 comprises receiving 510 a rating of at least one data source, and storing 520 the rating of the at least one data source.

The method may further comprise sending the rating of the at least one data source to a data analytics function. The stored previous rating of the at least one data source may comprise an historical rating of the at least one data source.

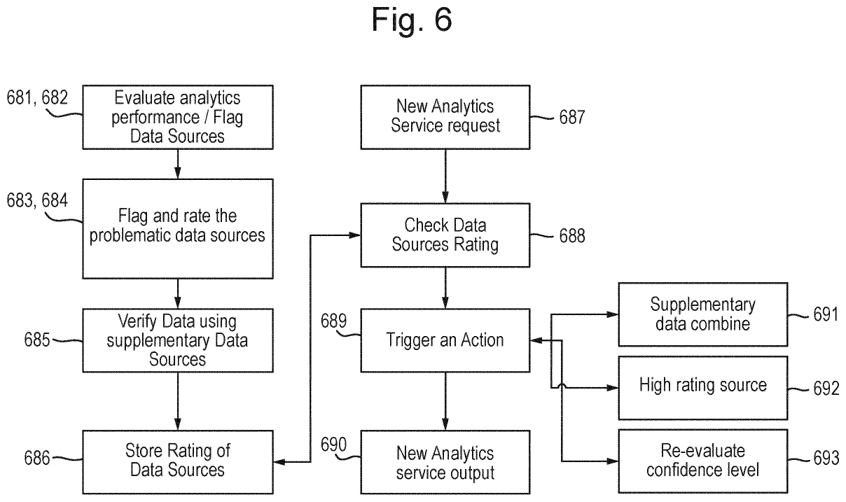

FIG. 6 illustrates the solution presented herein by way of the following high-level steps.

At 681, an analytics consumer requests and consumes analytics service from data analytics function (e.g. NWDAF ANLF). This may be implemented by a number of ways, two example options are presented as follows.
Option 1: The data analytics function requests and receives post-analytics evaluation of the consumed service (accuracy level, or optionally success/failure of prediction).
Option 2: Instead of getting evaluation from the consumer, it can be also possible that existing solutions (based on prior art, MTLF evaluates the correctness of data, or ANLF evaluates correctness of analytics) can be used to evaluate locally based on the correlation of predicted with ground-truth data or optionally trigger the checking of data source rating. For example, if an error is found based on other solutions, the ANLF/MTLF flags the wrong data to the rating function.

At 682, the data analytics function (or another function, e.g., like TRLF) processes the evaluation and identifies data sources (e.g., based on source ID) that deviate significantly from previous data statistics.

At 683, the analytics function (ANLF or MTLF) or another function flags the problematic data sources which were used as inputs in case of wrong data/bad evaluation. Such rating may lead to a down-weighting or even the blacklisting of a data source having a rating below a predetermined threshold. The predetermined threshold may be set by the MNO dependent on a desired QoS or QoE.

At 684, the analytics function (ANLF or MTLF) or another function can flag and then provide a rate or weight related to the data source ID indicating the accuracy of the input data. This rate or weight can also be stored in the ADRF in case of further use or can indicate if the data from the specific data source shall be stored in the ADRF at all (e.g., data from a data source having a rating below a certain predetermined threshold shall be not stored; the predetermined threshold may be set by the MNO dependent on a desired QoS or QoE).

Some sources may have a pre-defined rating, (e.g., OAM data sources) such that only some, other, sources are rated according to the proposed methods. Such other sources may comprise at least one of AF, UE, RAN nodes, and UPFs. Also, where a plurality of data sources contribute to a rated analytic such as from a particular AF, then the contribution weights of each of those data sources as used by the AF may be taken as input to rate at least one of the plurality of data sources.

At 685, the data analytics function discovers possible alternative sources and requests and receives supplementary data for the required input. If there is a deviation of the data distribution from alternative sources then the rating shall be lowered.

At 686, the data analytics function (or TRLF or ADRF) stores all the ratings for the data sources based on the deviations (assuming inputs from multiple requests). Such ratings can be quantized (e.g. low, medium, high) or expressed as a percentage value (% accuracy) or a delta offset comparing to the threshold, or in any other format (based on pre-configuration from MNO). If the rating is below a predetermined threshold, then the corresponding data may not be stored but discarded.

At 687, a new analytics request arrives at the analytics function, related to the target analytics service (based on Analytics ID).

At 688, the data analytics function retrieves and checks the ratings of the data sources for the analytics service. For example: where an MTLF requires training data to train an ML Model, the MTLF queries the rating function to find data sources (either historical data from ADRF) or new data.

At 689, if there is a data source that will lower the confidence of a prediction or a data source that is below a threshold rating, the analytics function performs one of the following:
Select the highest rating data source if more than one sources can provide similar data
Request supplementary data from other available data sources and uses them for verification of the data from low rated data source. Such supplementary data can be beneficial for certain analytics services (e.g. for analytics applying to any UE, e.g. area based) and the decision at NWDAF for using this considers also the complexity of acquiring data and data freshness etc. Alternatively or additionally, such supplementary data can be offline or live data. Such supplementary data can be beneficial for certain analytics services and the decision at NWDAF for using this considers also the complexity of acquiring data and data freshness etc.
Modify the confidence level of the analytics based on the accuracy/correctness rate of the one or more data source involved.

At 690, If the needed confidence level is reached and/or the data is verified, then the analytics function sends the analytics output to the consumer.

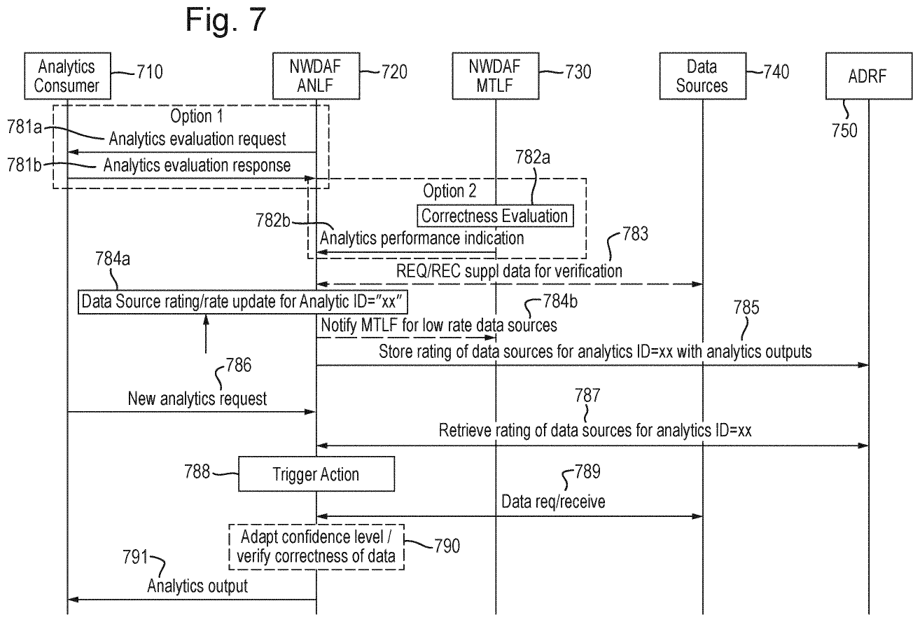

FIG. 7 illustrates an implementation for ANLF-based rating and storage at an ADRF. FIG. 7 shows an analytics consumer 710, an NWDAF ANLF 720, an MWDAF MTLF 730, an at least one data source 740, and an ADRF 750. This implementation shows the enhancements at ANLF 720 and the storage of ratings at ADRF 750. The process may be initiated in various ways, two such options are given as examples in FIG. 7.

Option 1, at 781a, after an analytics consumer 710 consumes analytics service with Analytics ID=“xx”, the NWDAF/ANLF 720 requests the consumer on the feedback/evaluation of the analytics service (good or bad, experience level, success or failure of prediction, with a possible cause).

At 781b. NWDAF/ANLF 720 receives the feedback as requested. (rate, success/failed, cause). Such a step can be performed multiple times to multiple consumers for the given service.

Option 2: at 782a, the NWDAF MTLF 730 evaluates the ML model correctness (using conventional approaches) or evaluates the performance of the analytics model, and based on this (e.g. checking the performance based on a pre-defined threshold) it may decide to notify ANLF 720 on the correctness.

At 782b, the NWDAF/ANLF 720 receives notification from the MTLF 730 which indicates possible low performance or correctness and optionally requesting ANLF 720 to further check the inference data/data sources for correctness.

In steps 782a/782b it is mentioned that MTLF 730 is evaluating the correctness (correlation of predictions with ground truth), but it is possible that also ANLF 720 performs correlation of predictions with ground truth. So, steps 782a/782b can have different signaling based on which node performs the evaluation.

At 783, the NWDAF/ANLF 720 conditionally (i.e., if needed) requests and receives additional data from different data sources 740 (if available) to verify the data source quality or correctness. Such data can be for example performance data from OAM which are supplementary to AF, or data from UPF supplementary from AF.

At 784a, the NWDAF/ANLF 720 updates the rating for the sources where data is deviated from the supplementary data (or in case step 783 is not implemented) the rating is automatically changed based on the analytics feedbacks in step 782b.

At 784b, ANLF 720 may also optionally notify MTLF 730 about the data source rating (if MTLF 730 is not already involved in this rating process), in case this is also used for training the ML model. Such notification may be used by the MTLF 730 to exclude that dat source from training or mark it as untrusted.

At 785, the NWDAF ANLF 720 stores the ratings to ADRF 750 or any other repository function (or this can be also stored within NWDAF 720). Optionally, if the rating of the data source is very low, it may decide not to store the data at the ADRF 750.

At 786, a new analytics request arrives from the analytics consumer 710 for analytics service with Analytics ID=“xx”.

At 787, the NWDAF/ANLF 720 retrieves the rating for the data sources corresponding to the analytics ID.

At 788, if the rating of one or more data sources is below a threshold (pre-set), then NWDAF ANLF 720 triggers an action of: selection of an alternative data source with highest rating; or the need for supplementary data from other available data sources and uses them for verification of the data from low rated data source.

At 789, if a new or additional data source is needed, the NWDAF ANLF 720 subscribes to the new data source 740, and requests/receives new data. Such request for data may take the form of a subscription.

At 790, the NWDAF ANLF 720 obtains analytics data and checks whether the confidence level is above a request threshold. The derivation of the threshold takes into account also the rating of the data sources (or an aggregated rating of the data sources based on the individual ratings). The NWDAF ANLF 720 may also verify/compare data of different sources on the same parameters.

At 791, the NWDAF ANLF 720 provides the analytics output to the analytics consumer 710.

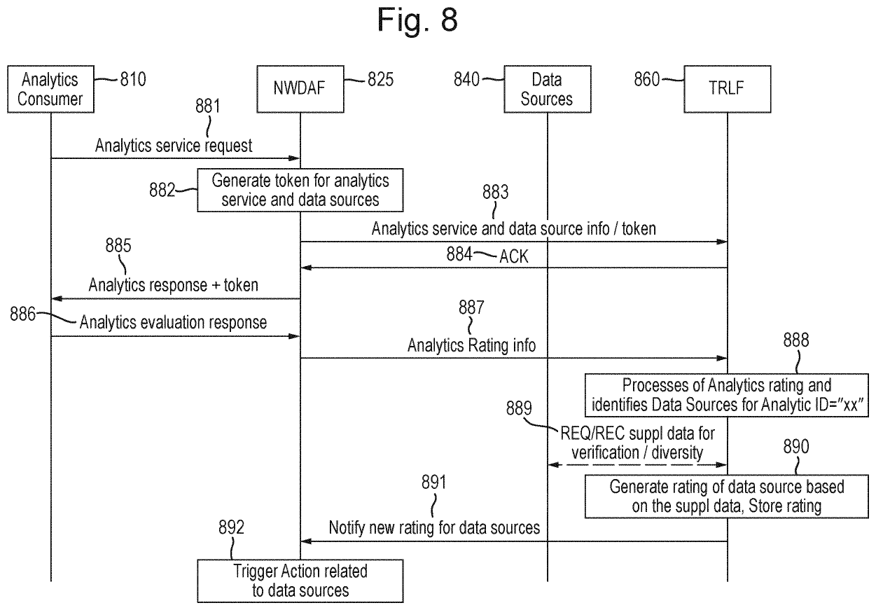

FIG. 8 illustrates an alternative implementation that uses a Trusted Rating Logical Function (TRLF) with another NF for performing data source rating. Here, another NF, e.g., similar to the TRLF, performs the rating of the data sources instead ANLF. FIG. 8 shows an analytics consumer 810, an NWDAF 825, an at least one data source 840, and a TRLF 860.

The process begins with the Analytics Consumer 810 discovering NWDAF 825, this is not shown in FIG. 8. Further, a mapping table of analytics service and Data Sources/inputs is already known at NWDAF 825. The mapping table may be provisioned to the NWDAF 825 from, for example, and OAM, not illustrated in FIG. 8. Typically, for the Data Sources that are a part of the network operator premises a fixed rating is provided as such data sources are with in control of the network operator and thus may be trusted to be accurate.

At 881, the Analytics consumer 810 requests an analytics service from the selected NWDAF 825 specifying also its Consumer ID comprising the NF (instance or Set) ID and Vendor ID.

At 882, the NWDAF 825 generates a token that can be used to rate the data sources corresponding to the analytics service.

At 883, the NWDAF 825 sends to the TRLF 860 information about the Consumer ID, Analytics ID, information on the ML model used for producing the analytics (if any), its own NWDAF 825 (instance or Set) ID, the Data Source IDs and addresses and/or the mapping table related to the analytics service and the token generated for the data source rating. In this way, the TRLF 860 can associate the rating from the Consumer 810 to the analytics service provided by the NWDAF 825 and, implicitly, to the ML model and the data sources used to generate it in case the analytics service is based on an ML model. Here an alternative/complementary option instead of getting from the consumer 810 the analytics rating, this is based on local rating at NWDAF (MTLF or ANLF) 825.

At 884, the TRLF 860 sends an acknowledgement to the NWDAF 825.

At 885, the NWDAF 825 sends the analytics response to the Analytics consumer 810 along with the token generated for allowing only verified consumers (i.e. only the ones that really have consumed the service) to evaluate the analytics service.

In case the analytics consumer 810 subscribed to the analytics service, the token is valid for the entire subscription duration and the consumer 810 may update its rating by sending another Ntrlf_AnalyticsRating request. Once the subscription is terminated, the NWDAF 825 shall inform the TRLF 860 about it, such that only a final rating can be provided by the consumer 810 after which the token is revoked.

At 886, the analytics consumer 810 evaluates the performance of the analytics service utilizing the metric obtained by NRF during the discovery procedure. Such evaluation metric can be the experience of the analytics service (e.g. poor, average, good) or a success or failure of the prediction. In case of failure of the prediction, the consumer 810 can also state cause of failure (to indicate if the failure was from the consumer side or from the analytics service).

At 887, the analytics consumer 810 through the Ntrlf_Analytics Rating service sends its rating to the TRLF 860. The request also includes the Consumer ID of the analytics consumer 810 and the received token.

At 888, the TRLF 860, in case the token matches and the analytics consumer 810 is not the model producer, processes the rating and maps to the data sources.

At 889, the TRLF 860 requests and receives supplementary data from different data sources 840 to verify the data sources 840.

At 890, the TRLF 860 of the rating of the data source 840 is changed (based on the verification of step 889 or automatically based on the analytics rating) translates the new rating to an update of the rating of the data source 840 for which the rating can change. The TRLF 860 stores the rating per Analytics ID and per Data Source ID and for each Consumer ID.

At 891, the TRLF 860 sends to the NWDAF 825 a notification regarding the update of the rating of the data sources if the rating has dropped from a pre-defined threshold. For example, such a threshold may be defined as below Average.

At 892, the NWDAF 825 checks the ratings of the data sources with low rate and performs one of the following: flag; change of mapping; or alert OAM. Specifically, the NWDAF 825 may flag the data source to request in further analytics requests supplementary data from other available data sources and uses them for verification of the data from low rated data source. Alternatively, the NWDAF 825 may update the mapping table to remove a data source or change the priority of the data source if more than one source can provide similar data. Alternatively still, the NWDAF 825 may send an alert to an OAM (not illustrated in FIG. 8) to indicate a possible blacklisting of the data source if the rating is very low (or wrong data have been provided multiple times).

It should be noted that the process described herein may also be applicable for the data analytics function being at OAM (MDAS as specified in 3GPP SA5) or at application layer (ADAES as defined in 3GPP SA6). Further, the rate can also be a weight related to data sources that can assist the ANLF to perform a selection considering the target confidence degree.

A problem addressed by certain arrangements described herein is how to detect possible drift and relate this drift to a specific data source and abnormal/unreliable behavior therein. Further, certain arrangements described herein define how the NWDAF, should dynamically react. For example, the NWDAF may select an alternative or complementary data source, to ensure minimum impact to the accuracy of the analytics service it provides.

Certain arrangements defined herein define how to detect an accuracy mismatch at the ML model inference and ensure correctness of analytics by enabling the rating of data sources. An NWDAF generates data source rating/weights/profiles/reputation which are used as criterion for selecting how and from which data sources and to collect data. Such a solution is able to capture possible drifts at the ML model inference which are due to the data sources. This solution is particularly useful for data sources that are UEs (via AF) or are AF which are not as trusted as OAM and NFs (as the analytics services exemplified above).

The solutions presented herein provide for the verification of the accuracy data sources and the rating of these data sources using alternative/supplementary data source to provide inputs for the analytics service.

There is provided a solution whereby an ANLF/NWDAF evaluates the performance of data sources, rates or assigns weight to the data sources and stores the ratings at ADRF. The ANLF/NWDAF can request complementary data source to improve NWDAF correctness. There is also provided a solution whereby a TRLF performs a rating of the data sources instead of the ANLF.

Accordingly, there is provided a method at a data analytics function for detecting accuracy of data for network analytics, the method comprising: obtaining an evaluation of the analytics service; determining a rating for one or more data sources of the analytics service, based on the evaluation of the analytics service outputs; identifying low rated data sources for the analytics service and/or analytics event; and triggering a correctness improvement action based on the rate of the data source.

The evaluation of the analytics service may be provided from a consumer or NWDAF [ANLF/MTLF] or from an AF.

The data source can be UE, AF. The data source may be outside of the control of an operator of the wireless communication network.

The action may comprise one or more of: requesting additional data from one or more further data sources; adapting the accuracy of analytics based on the rate; and/or updating the mapping of the one or more data source to the analytics service based on the identifying low reliability data sources.

The method may further comprise verifying data by comparing data from one or more data sources of the same type, and targeting the same analytics service or service are or analytics event.

The method may further comprise obtaining a data source contribution weight before determining the data source rate.

The method may further comprise storing the data source rates to a repository function. The repository function may be an ADRF.

The method may further comprise sending the data source rate and/or an event related to the correctness improvement action to at least one further network node and/or the consumer. Such sending may be performed after a triggering action.

The data source rating may be associated with an expected and/or pre-defined confidence degree.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field to which the present document relates: AF, Application Function; NF, Network Function; NWDAF, Network Data Analytics Function; OAM, Operations and Maintenance; UE, User Equipment; MDAS, Management Domain Analytics Service; ADAES, Application Data Analytics Enabler Service/Server; ANLF, Analytics Logical Function; MTLF, Model Training Logical Function; DNAI, Data Network Access Identifier; MOS, Mean Opinion Score; MDT, Minimization of Drive Tests; ADAEC, Application Data Analytics Enabler Client; TRLF, Trusted Rating Logical Function; and ML, Machine Learning.

1. A data analytics function comprising:
at least one memory; and
at least one processor coupled with the at least one memory and arranged to cause the data analytics function to:
generate analytics data for an analytics service using at least one data source;
receive an event related to the analytics service; and
determine a rating of the at least one data source, the rating based on supplementary data.

2. The data analytics function of claim 1 wherein the at least one processor is further arranged to cause the data analytics function to:
identify a rating of the at least one data source as below a predetermined threshold; and
trigger a corrective action based at least in part on the at least one data source having the rating below the predetermined threshold.

3. The data analytics function of claim 2, wherein the corrective action comprises the at least one processor arranged to cause the data analytics function to one or more of:
request the supplementary data from one or more other data sources;
update a stated accuracy of an analytics report; or
update a mapping of the one or more other data sources to the analytics service.

4. The data analytics function of claim 1, wherein the event is received by at least a network data analytics function model training logical function.

5. The data analytics function of claim 1, wherein the at least one data source comprises an application function.

6. The data analytics function of claim 1, wherein, to determine the rating of the at least one data source, the at least one processor is further arranged to cause the data analytics function to verify data from the at least one data source by comparing the data from the at least one data source with the supplementary data.

7. The data analytics function of claim 1, wherein, to determine the rating of the at least one data source, the at least one processor is arranged to cause the data analytics function to obtain a data source contribution weight.

8. The data analytics function of claim 1, wherein the at least one processor is arranged to cause the data analytics function to store the rating in a data storage entity.

9. The data analytics function of claim 1, wherein the at least one processor is arranged to cause the data analytics function to send the rating of the at least one data source to at least one network node.

10-11. (canceled)

12. The data analytics function of claim 1, wherein the rating is further based on previous data source ratings.

13. A method performed by a data analytics function, the method comprising:
generating analytics data for an analytics service using at least one data source;
receiving an event related to the analytics service; and
in response to receiving the event, determining a rating of the at least one data source, the rating based on supplementary data.

14. A data storage entity comprising:
at least one memory; and
at least one processor coupled with the at least one memory and arranged to cause the data storage entity to:
receive a rating of at least one data source; and
store the rating of the at least one data source.

15. The data storage entity of claim 14, wherein the at least one processor is arranged to cause the data storage entity to send the rating of the at least one data source to a data analytics function.

16. A method performed by a data storage entity, the method comprising:
receiving a rating of at least one data source; and
storing the rating of the at least one data source.

17. The method of claim 16, further comprising sending the rating of the at least one data source to a data analytics function.

18. The method of claim 13, further comprising:
identifying a rating of the at least one data source as below a predetermined threshold; and
triggering a corrective action based at least in part on the at least one data source having the rating below the predetermined threshold.

19. The method of claim 18, wherein the corrective action further comprises at least one of:
requesting the supplementary data from one or more other data sources;
updating a stated accuracy of an analytics report; or
updating a mapping of the one or more other data sources to the analytics service.

20. The method of claim 13, wherein the determining the rating of the at least one data source further comprises verifying data from the at least one data source by comparing the data from the at least one data source with the supplementary data.

21. The method of claim 13, further comprising storing the rating in a data storage entity.

22. The method of claim 13, further comprising sending the rating of the at least one data source to at least one network node.
